(19) United States
(12) Patent Application Publication
(10) Pub. No.: US 2005/0283290 A1
(43) Pub. Date: Dec. 22, 2005

(54) Device and method to influence the steering behavior of a vehicle

(76) Inventors: Horst Krimmel, Tettnang (DE); Claus Granzow, Tettnang (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/157,263

(22) Filed: Jun. 21, 2005

(30) Foreign Application Priority Data
Jun. 21, 2004 (DE) 10 2004 029 783.5

(51) Int. Cl. G06F 7/00

(52) U.S. Cl. 701/41; 701/71

(57) ABSTRACT

The invention refers to a process for influencing the steering behavior of a motor vehicle that has at least one differential lock and a steering system with which the first yawing moment (M_{G}) can be generated, as well as a supplemental angle (δ_{ZL}), which can override the driver steering angle (δ_{FL}) and with which a second yawing moment (M_{G}) can be generated. Hereby, according to the invention, the supplemental angle (δ_{ZL}) can be calculated and that a second yawing moment can be generated that compensates for the first yawing moment (M_{G}).

The invention refers to a process for influencing the steering behavior of a motor vehicle that has at least one differential lock and a steering system in which the driver controlled driver steering angle is superposable by a supplemental steering angle, according to the preamble of the patent claim 1.

Steering overrides are known from DE-A 40 31 316 or DE-C 43 26 355, for example. They point out a planetary gear with two input waves and one output wave whereby a driver-desired driver steering angle is entered over the first input wave and a supplemental steering angle, for example, is entered by means of an electric motor over the second input wave so that the supplemental steering angle overrides the driver steering angle. The steering angle is then transmitted to the front wheels over the output wave of the active front steering. That makes it possible to achieve a variable steering reduction ratio, which is also known under the designation of an “active steering”, e.g., from a prospectus of the ZF Steering Systems GmbH Co.

A process for operating a steering system of a motor vehicle with an override control (AFS=Active Front Steering) is known from DE-A 102 18 579 which has a main entry for a driver steering angle and a side entry for a supplemental steering angle. With this type of steering intervention, the driving dynamic of the motor vehicle can be influenced. It is advantageous in case of active front steering that a mechanical linkage is located between the steering wheel and the steerable front wheels, which increases the safety of the vehicle.

Also known are the so called steer-by-wire systems wherein the mechanical linkage between the steering wheel and the steering mechanism can be fully replaced by electromechanical components. Here also, the supplemental steering angle can override the driver setting of the driver steering angle.

It is also known that in the case of an unexpectedly occurring yawing moment by the motor vehicle, a steering intervention is to be undertaken, e.g., in the case of a so called μ-split situation, i.e., in the case of different friction values on the left and on the right side of the roadway. Described in DE-A 40 38 079 is a vehicle with an anti-blocking system (ABS) wherein, in case of μ-split braking, a compensation steering angle is overridden in order to balance out the yawing moment caused by the μ-split situation. Herein, the compensation steering angle is dependent on the dominant application of the brake or, as the case may be, the calculated brake pressure difference between the right and the left wheel. The locking of the wheels generated by the compensation steering angle compensates for the yawing moment.

The invention is based on a driving situation as it occurs in vehicles with a differential lock. Such differential locks are known and are used preferably for utility and all-terrain vehicles in order to prevent the spinning of a wheel under propulsion. If the vehicle with a differential lock enters a μ-split roadway and the spinning wheel is stopped by the means of the differential lock, an unwanted yawing moment is produced to the vehicle driver. Herein, the vehicle attempts to return to the track on the side of the lower friction value. The differential locks can also, for example, be represented by a differential transmission with a multiple disk clutch or an electronic control of the vehicle brakes.

It is the task of the instant invention to provide relief for the driver of a vehicle with a differential lock from a yawing moment occurring through the effects of the differential lock, i.e., to compensate extensively for the yawing moment.

This task will be solved through a procedure with the characteristics of patent claim 1, as well as through a device with the characteristics of claims 7 or 8, as well as through the use of a process or a device with the characteristics of claim 9. In a vehicle with a differential lock and a steering system according to the invention, a supplemental steering angle can override the driver steering angle, assuming that a first-occurring yawing moment can be compensated by a second yawing moment. The supplemental steering angle, calculated and entered at the occurrence of the first yawing moment, leads to locking of the wheel which counteracts the first yawing moment, for example, caused by the entry of the vehicle onto a μ-split roadway. The vehicle's supplemental steering angle then generates a second yawing moment, which does not correspond rate wise to the first yawing moment but counteracts and thus compensates for it. The person steering the vehicle is thus provided relief, that is to say, he does not have to counter steer, or just a very little, in order to maintain the vehicle on a straight course.

In an advantageous design of the invention, the size of the supplemental steering angle can be calculated by a computer depending on the various parameters that can be measured by the vehicle. Among these parameters are: the wheel revolutions or, as the case may be, the differential numbers derived from it on the differential lock or, as the case may be, its lock clutch, further the recorded friction values, the transferred clutch moments, and the engine moment, the frequency of brake actuation, the vehicle speed, the driver steering angle and the vehicle yawing rate, that is to say, angle speed about the vehicle vertical axis. The supplemental angle can be calculated from these values through which the override of the yawing moment can be largely compensated.

After further alternative improvements of the invention, the supplemental angle can also be calculated directly from the effect of the differential lock on the occurring yawing moment, for example, based on the wheel revolutions, the vehicle speed, the friction values, the actuation of the clutch, the wheel steering angle, on the driver steering angle, as well as the yawing rate of the vehicle. The yawing moment can thus be calculated or estimated and entered into the override. The steering intervention resulting from it, that is to say, the locking of the front wheels also leads to a yawing moment compensation.

The invention design examples are represented in the drawing and will be described in greater detail in the following. It shows:

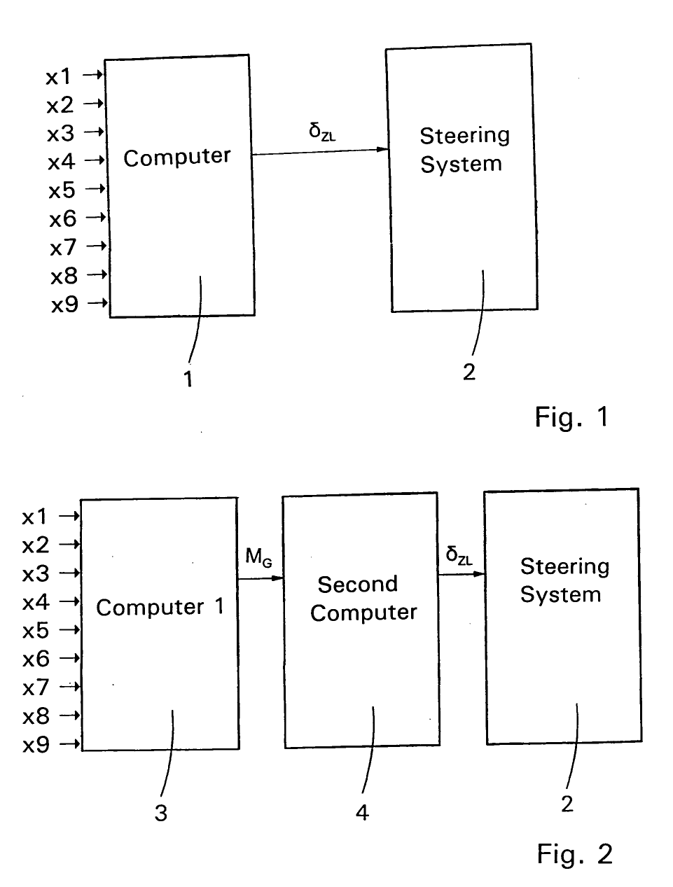

FIG. 1 a block diagram figure for calculating a supplemental angle;

FIG. 2 an alternative for calculating of a supplemental angle; and

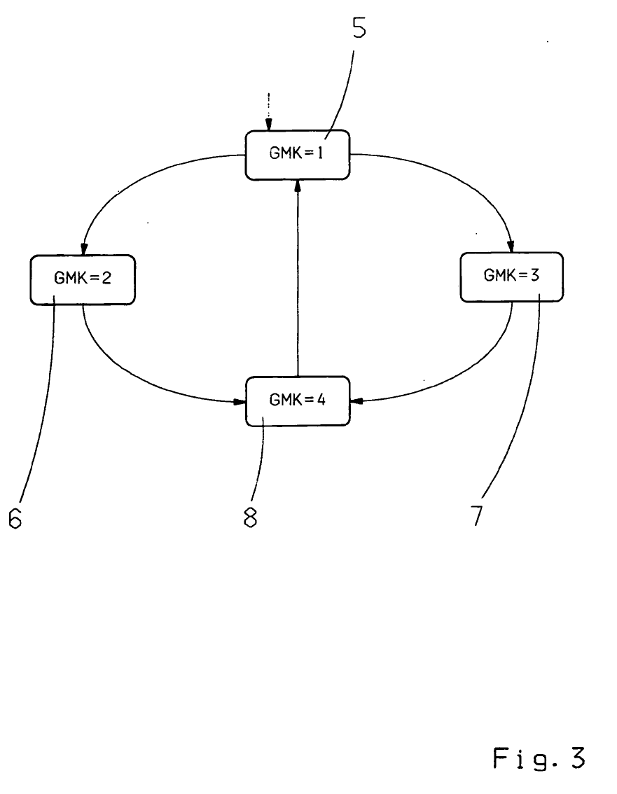

FIG. 3 a status diagram for a yawing moment compensation.

FIG. 1 shows a block diagram figure for calculating a supplemental angle δ_{ZL}. Diverse parameters designated as x1 to x9 are entered into a computer 1, represented as a block. From these data, the computer 1 calculates the supplemental angle δ_{ZL} which is entered into a steering system 2. In the steering system 2, the supplemental angle δ_{ZL} will override a driver steering angle δ_{FL} set for the course by the vehicle driver and transmit it as a wheel steering angle to the front wheels of the motor vehicle. The supplemental angle δ_{ZL} represented here then immediately carries out the correction of the driver selected driver steering angle δ_{FL}. This correction of the driver steering angle δ_{FL} will produce a second yawing moment for the vehicle over the steering system 2. According to the invention, the supplemental angle δ_{ZL} is now calculated so that the second yawing moment produced by it compensates for the first yawing moment M_{G}, that was caused by the effect of the differential lock. The first yawing moment M_{G} of the differential lock is evoked, for example, by the roadway with varied friction values for the different wheels under propulsion (a μ-split situation) and is undesirable. When the vehicle enters a μ-split situation and a brake is applied to the spinning wheel by means of the differential lock, this results in the first yawing moment M_{G}, which turns the vehicle in the direction toward the lower friction value. This first yawing moment M_{G} effect is counteracted by the second yawing moment brought about by the supplemental angle δ_{ZL}. The supplemental angle δ_{ZL} is calculated from at least one of the x1 to x9 parameters, whereby they have the following significance:
x1: Wheel revolutions of the vehicle
x2: Vehicle speed
x3: Friction values
x4: Yawing of the differential lock clutch
x5: Engine moment
x6: Brake actuators
x7: Driver steering angle δ_{FL}
x8: Wheel steering angle δ_{RL}
x9: Yawing rate ω_{Z} (angle speed about the z-axis of the vehicle).

From these parameters, a suitable supplemental angle δ_{ZL} is calculated, which causes a second yawing moment over the wheel lock and through the steering system 2, which counteracts the first yawing moment M_{G} from the differential lock. Thus, the driver is relieved and freed from counter steering the vehicle. When the μ-split situation no longer exists, a yawing moment compensation is no longer required and the supplemental angle δ_{ZL} will be brought back, within a preset time period, to a zero value. It is not followed by any further steering wheel interventions.

FIG. 2 shows an alternative calculating method represented in a block diagram, whereby the block 3 again represents a computer into which diverse parameters x1 to x9 have been entered. As a result of the intervention of the differential lock by means of these parameters x1 to x9 explained below, which correspond to the above designated parameters x1 to x9, the resulting first yawing moment M_{G} will be calculated. The value of this first yawing moment M_{G} will be supplied to the block 4 as an input signal where the supplemental angle δ_{ZL} will be calculated which, in turn, will be entered into the steering system 2. There an override with the driver steering angle δ_{FL} takes place and generates a wheel steering angle for the front wheels. The calculation of the supplemental angle δ_{ZL} takes place, in this alternative, over the size of the yawing moment M_{G}; to that extent, the supplemental angle δ_{ZL} and the resulting steering intervention are immediately matched to the first yawing moment M_{G}.

The parameters entered in the computer 3 signify:
x1: Vehicle wheel revolutions,
x2: Vehicle speed,
x3: Friction values,
x4: Clutch moment of the differential lock,
x5: Engine moment,
x6: Brake actuators,
x7: Driver steering angle δ_{FL},
x8: Wheel steering angle δ_{RL},
x9: Yawing rate ω_{Z} (angle speed about the Z-axis of the vehicle).

A μ-split situation can be recognized in at least one of the x1 to x9 or y1 to y9 parameters.

1-9. (canceled)

10. A method for affecting the steering behavior of a vehicle having at least one differential lock in which a first yawing moment (M_{G}) can be generated, as well as with a steering system (2) in which a supplemental angle (δ_{ZL}) can override a driver steering angle (δ_{FL}),
the method comprising the step of setting the supplemental angle (δ_{ZL}) in such way that a second yawing moment, arising from the supplemental angle (δ_{ZL}), compensates for the first yawing moment (M_{G}).

11. The method according to claim 10, further comprising the step of calculating the first yawing moment (M_{G}) in dependence on at least one of the following parameters:
x1: Vehicle wheel revolutions,
x2: Vehicle speed,
x3: Friction values,
x4: Clutch moment of the differential lock,
x5: Engine moment,
x6: Brake presses,
x7: Driver steering angle δ_{FL},
x8: Wheel steering angle δ_{RL}, and
x9: Yawing rate ω_{Z} (angle speed about the Z-axis of the vehicle).

12. The method according to claim 10, further comprising the step of calculating the supplemental angle δ_{ZL} in dependence on at least one of the following parameters:
x1: Vehicle wheel revolutions,
x2: Vehicle speed,
x3: Friction values,
x4: Clutch moment of the differential lock,
x5: Engine moment,
x6: Brake actuation,
x7: Driver steering angle δ_{FL},
x8: Wheel steering angle δ_{RL}, and
x9: Yawing rate ω_{Z} (angle speed about the z-axis of the vehicle).

13. The method according to claim 10, further comprising the step of calculating the supplemental angle (δ_{ZL}) in dependence on the first yawing moment (M_{G}).

14. The method according to claim 10, further comprising the step of recognizing a μ-split situation in at least one of the parameters (x1 to x9).

15. The method according to claim 10, further comprising the step of, in case of a loss of the first yawing moment (M_{G}) of the differential lock, the supplemental angle (δ_{ZL}) is returned to a zero value after a given time span.

16. A motor vehicle with a device for affecting the steering behavior of the vehicle having at least one differential lock in which a first yawing moment (M_{G}) can be generated, as well as with a steering system (2) in which a supplemental angle (δ_{ZL}) can override a driver steering angle (δ_{FL}),
wherein a computer (1) calculates the first yawing moment (M_{G}) based on parameters (x1-x9) and the supplemental angle (δ_{ZL}), and the supplemental angle (δ_{ZL}) is set in such way that a second yawing moment arising from the supplemental angle (δ_{ZL}) compensates for the first yawing moment (M_{G}).

17. The motor vehicle with a device according to claim 16, in which a supplemental angle (δ_{ZL}) can override a driver steering angle (δ_{FL}) and where the first yawing moment (M_{G}) can be calculated in a computer (3) based on parameters (x1-x9), as well as a second computer (4) in which it can be calculated on basis of the first yawing moment (M_{G}) and the supplemental angle (δ_{ZL}).

18. The motor vehicle with the device according to claim 16, with at least a differential lock as well as a steering system (2) in which a supplemental angle (δ_{ZL}) can override a driver steering angle (δ_{FL}).
